(19) United States
(12) Patent Application Publication
(10) Pub. No.: US 2025/0007932 A1
(43) Pub. Date: Jan. 2, 2025

(54) ANOMALY DETECTION USING EVENT SEQUENCE PREDICTION

(71) Applicant: INTERNATIONAL BUSINESS MACHINES CORPORATION, ARMONK, NY (US)

(72) Inventors: Qing Wang, Sunnyvale, CA (US); David Christopher Ferguson Rayner, San Jose, CA (US); Panagiotis Lampropoulos, IJmuiden (NL); Huy Tran, Santa Clara, CA (US); Steven Nicholas Eliuk, San jose, CA (US)

(21) Appl. No.: 18/343,711

(22) Filed: Jun. 28, 2023

(51) Int. Cl. H04L 9/40; H04L 41/16

(52) U.S. Cl. CPC H04L 63/1425; H04L 41/16

(57) ABSTRACT

A method and system for anomaly detection using event sequence prediction include a conversation module applying a system topology to historical log data to generate first structured event sequences as training data. An event sequence generation engine then builds a machine learning model using the training data. The conversation module then applies a system topology to runtime log data to generate a second plurality of structured event sequences. The generation engine then runs the second structured event sequences through the machine learning model. The generation engine then calculates a probability for each of the second structured event sequences using the machine learning model. The generation engine then identifies probabilities for each of the second structured event sequences that are lower than a probability threshold of classified event sequences of the first structured event sequences are identified as an anomaly.

### BACKGROUND

### Technical Field

The present disclosure generally relates to methods and systems for anomaly detection, and more particularly, to methods and systems for anomaly detection using event sequence prediction with weakly supervised learning.

### Description of the Related Art

Log data consists of the set of records relative to all events that occur in relation to a system. When a system logs data, the log files are timestamped during creation. Log data typically includes detailed information relating to events and may include who was involved with the event, how the event occurred, where the event occurred, and when the event occurred. In a distributed system, multiple applications communicate with each other in order to carry out an operation. Each application creates their own log data, where it is stored in the same or different locations. Log data can be helpful when events are analyzed during a specific period of time.

### SUMMARY

According to an embodiment of the present disclosure, a method for anomaly detection using event sequence prediction includes an event sequence conversation module and an event sequence generation engine. The method includes applying, by the event sequence conversation module, a system topology to historical log data to generate a first plurality of structured event sequences labeled as training data. Once the event sequence conversation module applies a system topology to the historical log data, the event sequence generation engine builds a machine learning model using the training data, where the event sequence generation engine calculates a probability threshold for each of the first plurality of structured event sequences using the machine learning model. The event sequence conversation module then applies a system topology to runtime log data to generate a second plurality of structured event sequences. The event sequence generation engine then runs the second plurality of structured event sequences through the machine learning model. Once the event sequence generation engine runs the second plurality of structured event sequences through the machine learning model, the event sequence generation engine calculates a probability for each of the second plurality of structured event sequences using the machine learning model. The event sequence generation engine then identifies the probabilities for each of the second plurality of structured event sequences that are lower than the probability threshold of classified event sequences of the first plurality of structured event sequences as anomalies.

According to an embodiment of the present disclosure, a computer program product for anomaly detection using event sequence prediction is provided. The computer program product includes a computer readable storage medium embodying program instructions executable by a processor to cause the processor to perform a plurality of steps. An event sequence conversation module then applies a system topology to historical log data to generate a first plurality of structured event sequences labeled as training data. Once the event sequence conversation module applies a system topology to the historical log data, an event sequence generation engine builds a machine learning model using the training data, where the event sequence generation engine calculates a probability threshold for each of the first plurality of structured event sequences using the machine learning model. The event sequence conversation module then applies a system topology to runtime log data to generate a second plurality of structured event sequences. The event sequence generation engine then runs the second plurality of structured event sequences through the machine learning model. Once the event sequence generation engine runs the second plurality of structured event sequences through the machine learning model, the event sequence generation engine calculates a probability for each of the second plurality of structured event sequences using the machine learning model. The event sequence generation engine then identifies the probabilities for each of the second plurality of structured event sequences that are lower than the probability threshold of classified event sequences of the first plurality of structured event sequences as anomalies.

According to an embodiment of the present disclosure, a computing system is provided. There is a processor, a network module coupled to the processor to enable communication over a network, a non-transitory computer-readable storage device coupled to the processor, a graphical user interface coupled to the processor, an event sequence conversation module coupled to the network module, and an event sequence generation engine coupled to the network module. Program instructions are stored on the non-transitory computer-readable storage device for execution by the processor via a memory.

According to an embodiment, a computing system, in conjunction with the program instructions, is configured to perform a method for anomaly detection using event sequence prediction. The event sequence conversation module then applies a system topology to historical log data to generate a first plurality of structured event sequences labeled as training data. Once the event sequence conversation module applies a system topology to the historical log data, the event sequence generation engine builds a machine learning model using the training data, where the event sequence generation engine calculates a probability threshold for each of the first plurality of structured event sequences using the machine learning model. The event sequence conversation module then applies a system topology to runtime log data to generate a second plurality of structured event sequences. The event sequence generation engine then runs the second plurality of structured event sequences through the machine learning model. Once the event sequence generation engine runs the second plurality of structured event sequences through the machine learning model, the event sequence generation engine calculates a probability for each of the second plurality of structured event sequences using the machine learning model. The event sequence generation engine then identifies the probabilities for each of the second plurality of structured event sequences that are lower than the probability threshold of classified event sequences of the first plurality of structured event sequences as anomalies.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computing environment that can communicate with various networked components, consistent with an illustrative embodiment.

FIG. 2 presents a computing system for anomaly detection using event sequence prediction, consistent with an illustrative embodiment.

FIG. 3 is a flowchart showing an example process for anomaly detection using event sequence prediction performed in the computing system shown in FIG. 2, consistent with an illustrative embodiment.

FIG. 4A is a flowchart showing a microservices architecture of an example distributed system, consistent with an illustrative embodiment.

FIG. 4B presents example computer readable code presenting partial logs of error propagation among microservices of the example distributed system of FIG. 4A, consistent with an illustrative embodiment.

FIG. 5 is an example log data set embodying an event sequence conversation, consistent with an illustrative embodiment.

FIG. 6A is a flowchart showing an example of a conversion of time-based log data to a structured event sequence, consistent with an illustrative embodiment.

FIG. 6B is a graphical representation of an event sequence conversation, consistent with an illustrative embodiment.

FIG. 7A is a flowchart showing an example microservices architecture of a publicly benchmarked train ticket system including a root cause of abnormal events, consistent with an illustrative embodiment.

FIG. 7B is a flowchart showing an example process of forming a structured event sequence from events mapped on a time window, consistent with an illustrative embodiment.

FIG. 8A is a flowchart showing an example architecture of a sequence generative adversarial net (SeqGAN) including a policy gradient, consistent with an illustrative embodiment.

FIG. 8B is a flowchart showing an example architecture of an event sequence generation engine, consistent with an illustrative embodiment.

FIG. 9A is an objective equation of a reinforcement learning reward mechanism, consistent with an illustrative embodiment.

FIG. 9B is a set of equations each presenting a derivative of the rewards function of FIG. 9A at the event sequence level and the event token level, consistent with an illustrative embodiment.

FIG. 10 is an equation presenting an event sequence reward function including a bias portion, consistent with an illustrative embodiment.

FIG. 11 is a flowchart showing an example process for anomaly detection using event sequence prediction performed in the computing system shown in FIG. 2, consistent with an illustrative embodiment.

FIG. 12 is a flowchart for a method for anomaly detection using event sequence prediction, consistent with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The analysis of IT log data (including metrics collected by monitoring systems) of a running system provides the possibility to detect anomalous states early, avoiding further physical damage and business loss in a distributed system. Many system logs are produced by several concurrently running tasks, so it cannot guarantee log messages are in order, even if all of the system logs include timestamps. The available “good quality” of event sequence paired data is not sufficient. Auto-generated data can be partially labeled by human feedback for training purposes.

Further in relation to IT log data, many system logs are produced by several concurrently running tasks and there is no guarantee that log messages are in order, even if the log messages all include a timestamp. The order of logs can provide important information for diagnosis and analysis (for example, identifying the execution path of a program). However, the available amount of “good quality” event sequence paired data is not sufficient to necessarily carry out the diagnosis and analysis. In the case of auto-generated data, the data can be partially labeled by human feedback for training purposes.

Further in relation to IT log data, the disclosed methods and systems can detect anomalous states early and avoid further physical damage and business loss in the cloud environment. The disclosed methods and systems can improve the accuracy of anomaly detection and the speed of solving technical issues in the cloud environment. Anomalies/risks can be detected/predicted before serious problems occur, the processes of which can be applied across other domains (such as, for example, bank transaction anomaly detection) and is not limited only to the cloud environment. In one aspect, labeled data can be generated that can be applied to train machine learning models for tasks across other domains (such as, for example, bank transaction anomaly detection) and is not limited only to the cloud environment. The disclosed methods and system can enable anomaly detection data augmentation, and revenue opportunities based on adversarial reinforcement learning. The need to utilize massive sets of hand-labeled training data to teach a machine learning model to a computing device is reduced. It is noted that some embodiments disclosed may not include any of the aforementioned potential advantages and these potential advantages are not necessarily required of all embodiments.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

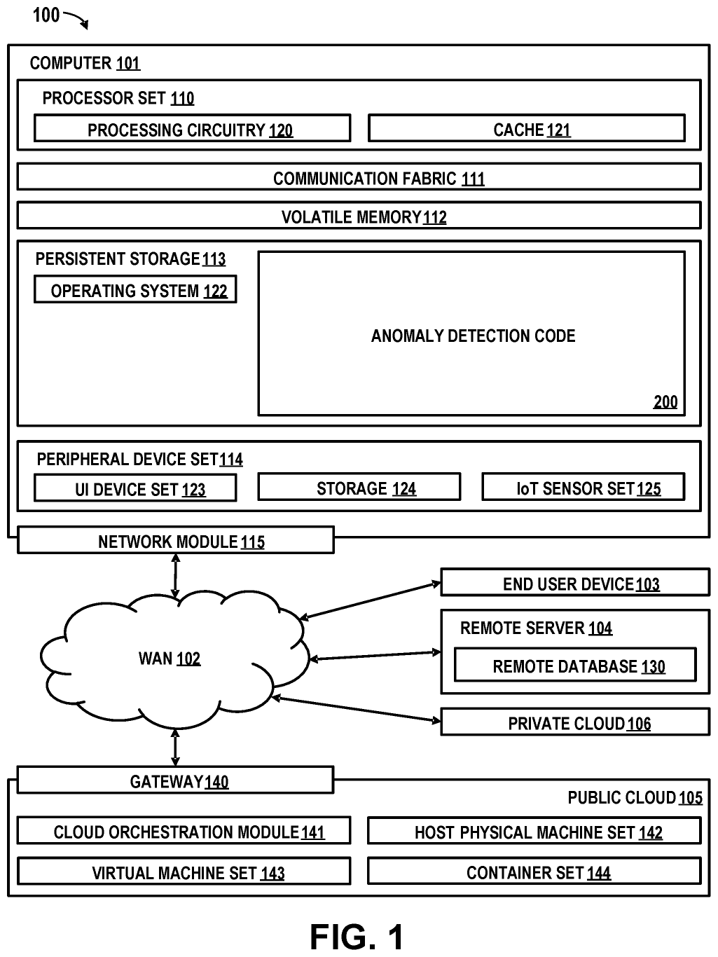

FIG. 1 is a functional block diagram illustration of a computing environment 100 that can communicate with various networked components, such as the cloud, a policy data source, etc. In particular, FIG. 1 illustrates a computing environment 100, as may be used to implement a component, such as, for example, a data preprocessing module 230, an event sequence conversation module 250, and an event sequence generation engine 260.

Computing environment 100 includes an example of an environment for the execution of at least some of the computer code involved in performing the inventive methods, such as anomaly detection code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure generally relates to systems and methods for anomaly detection using event sequence prediction. By virtue of the concepts discussed herein, a weakly supervised learning cycle is utilized to generate an event sequence for early detection of anomalies in IT log data of a distributed system. In an embodiment, the generated event sequence can include a service topology structure constraint. These embodiments can help increase efficiency of executions of one or more computing devices in IT operations and service management such as, for example, diagnosis, anomaly detection, fault localization, remediation of an issue, and change risk assessment. Additionally, the event sequence generated can be configured to be informative, coherent and reasonable in order to be utilized. It is noted that some embodiments disclosed may not include any of the aforementioned potential advantages and these potential advantages are not necessarily required of all embodiments.

### Example Architecture

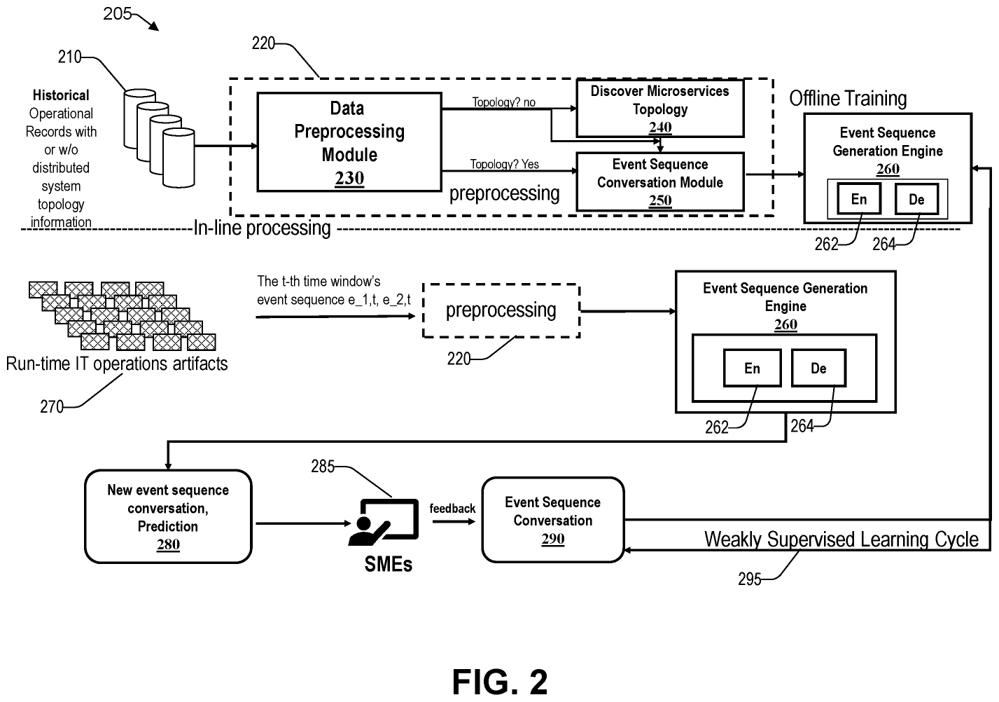

Reference is now made to FIG. 2, which is a computing system 205 for anomaly detection using event sequence prediction, consistent with an illustrative embodiment. Computing system 205 utilizes an adversarial reinforcement learning model to predict log event sequences using defined reward incentives trained on historical data. This functionality can improve the effectiveness of anomaly detection/prediction within or outside of a cloud environment.

As shown, a network module (similar to network module 115 of FIG. 1) provides coupling between various components of computing system 205 so that log event sequence data is shared between the components that are configured to perform event sequence prediction for anomaly detection and include a data preprocessing module 230 (preprocessing module 230), an event sequence conversation module 250, and an event sequence generation engine 260. The network module is coupled to a processor to enable the processor communication over a network established by the network module. Persistent storage (similar to persistent storage 113 of FIG. 1) and a graphical user interface (GUI) is coupled to the processor. The GUI is coupled to the processor to enable communication between computing system 205 and a user of computing system 205 (such as, for example, SMEs 285). Additionally, data, such as historical operational records 210 are stored on storage (similar to storage 124 of FIG. 1) and run-time IT operations artifacts 270 (alternatively referred to as runtime log data 270) are stored on persistent storage.

At block 220, preprocessing of historical operational records 210 (including or not including distributed system topology information) is performed. Historical operational records 210 are provided to data preprocessing module 230 via the storage. During the preprocessing (data preprocessing module 230), repeated data and noise/special characters are removed from historical operational records 210 (historical log data); additionally, within an event, unique tokens are replaced with defined fixed tokens in order to reduce the vocabulary size (domain-specific vocabulary). More specifically, each log entry is processed as a log template. As an example, a log entry “e”=“CPU usage is 95%”; the log entry “e” is converted by data preprocessing module 230 to “CPU usage is *%.” In this embodiment, each log template is represented by an embedding vector using the domain-specific vocabulary (which is sparse).

Data preprocessing module 230 is coupled to event sequence conversation module 250 to enable transfer of historical operational records 210 from storage. During a second phase of preprocessing at block 220, if there is no distributed system topology information relative to historical operational records 210, the microservices topology of historical operational records 210 is discovered at block 240. In an embodiment, a causality model is utilized to create the microservices topology. Once the topology is discovered (or had already been included with historical operational records 210), historical operational records 210 are sent to event sequence conversation module 250, where a system topology is applied to historical log data 210 to generate a first plurality of structured event sequences labeled as training data. In an embodiment, event sequence conversation module 250 constructs the first plurality of structured event sequences using log timestamps. Once historical operational records 210 are preprocessed, offline training of event sequence generation engine 260 is performed. Event sequence generation engine 260 includes encoder 262 and decoder 264 that are utilized to encode and decode the first plurality of structured event sequences to create an output configured as a reconstructed input based on learned features and patterns.

In relation to an in-line processing portion of computing system 205, run-time IT operations artifacts 270 are provided to data preprocessing module 230 at block 220 via persistent storage, where similar processing steps as described above in relation to the offline training are performed on the t-th time window's event sequence (e_1, t, e_2, t). Once preprocessing is completed at block 220, the runtime log data 270 is provided to event sequence generation engine 260, where an output in the form of a new event sequence conversation/prediction 280 (second plurality of structured event sequences 280) is produced. New event sequence conversation/prediction 280 is subsequently provided to GUI for SMEs 285 (Subject Matter Experts) to review and/or amend accordingly. Once feedback is provided by SMEs 285, event sequence conversation 290 is produced. Event sequence conversation 290 is subsequently fed to event sequence generation engine 260 at timed intervals in order to continue refining event sequence conversation 290 (weakly supervised learning cycle 295).

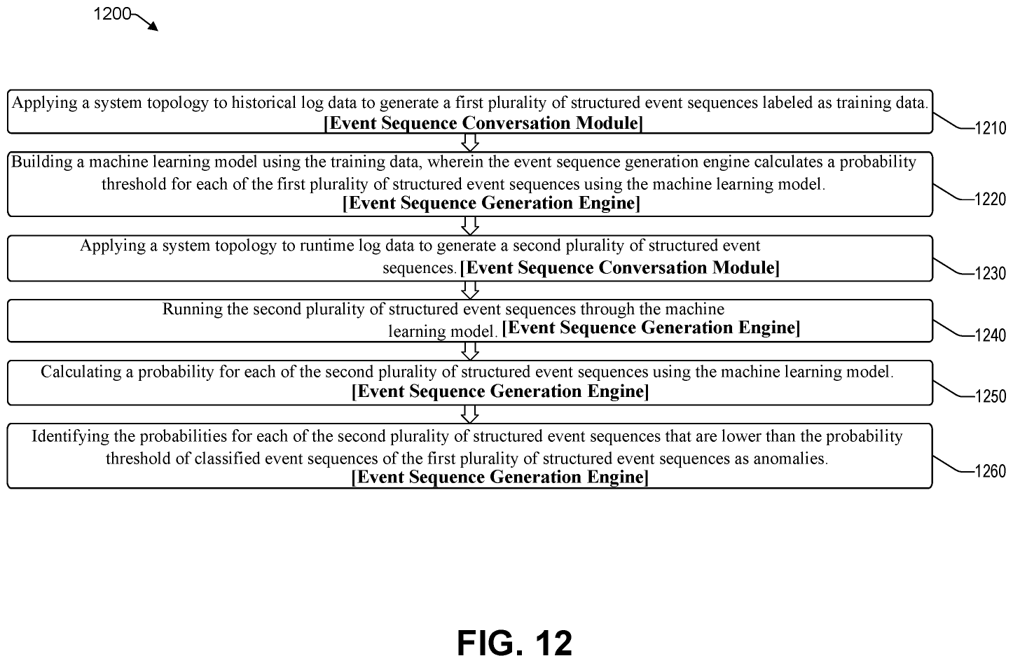

Program instructions (additionally referred to as anomaly detection code 200) stored on the non-transitory computer-readable storage device are configured for execution by the processor via a memory (similar to the volatile memory 112 of FIG. 1) coupled to the processor. The instructions are configured to render computing system 205 capable of performing a number of operations in a method for anomaly detection using event sequence prediction (presented similarly in FIG. 12). The method includes applying, via the event sequence conversation module 250, a system topology to historical log data 210 to generate a first plurality of structured event sequences labeled as training data. Once the event sequence conversation module 250 applies a system topology to the historical log data 210, the event sequence generation engine 260 builds a machine learning model using the training data, where the event sequence generation engine 260 calculates a probability threshold for each of the first plurality of structured event sequences using the machine learning model. The event sequence conversation module 250 then applies a system topology to runtime log data 270 to generate a second plurality of structured event sequences 280. The event sequence generation engine 260 then runs the second plurality of structured event sequences 280 through the machine learning model. Once the event sequence generation engine 260 runs the second plurality of structured event sequences 280 through the machine learning model, the event sequence generation engine 260 calculates a probability for each of the second plurality of structured event sequences 280 using the machine learning model. The event sequence generation engine 260 then identifies the probabilities for each of the second plurality of structured event sequences 280 that are lower than the probability threshold of classified event sequences of the first plurality of structured event sequences as anomalies.

For the purposes of this disclosure, the term “classified event sequences”, in relation to event sequences, refers to event sequences (from training data) that have been analyzed/used to build the machine learning model by event sequence generation engine 260.

In an embodiment, event sequence generation engine 260 utilizes an adversarial reinforcement learning model. In a further embodiment, a SeqGAN model/architecture is utilized to guide a generator of event sequence generation engine 260 to continuously improve the generator's performance in relation to log event sequence generation.

In one embodiment, historical log data 210 and runtime log data 270 are extracted from a distributed system.

In one embodiment, each log entry of historical log data 210 and runtime log data 270 that are processed by preprocessing module 230 is processed as a log template.

In one embodiment, the probability threshold is formed using an event sequence reward including a number of correctly ordered generated event sequences based on a system topology.

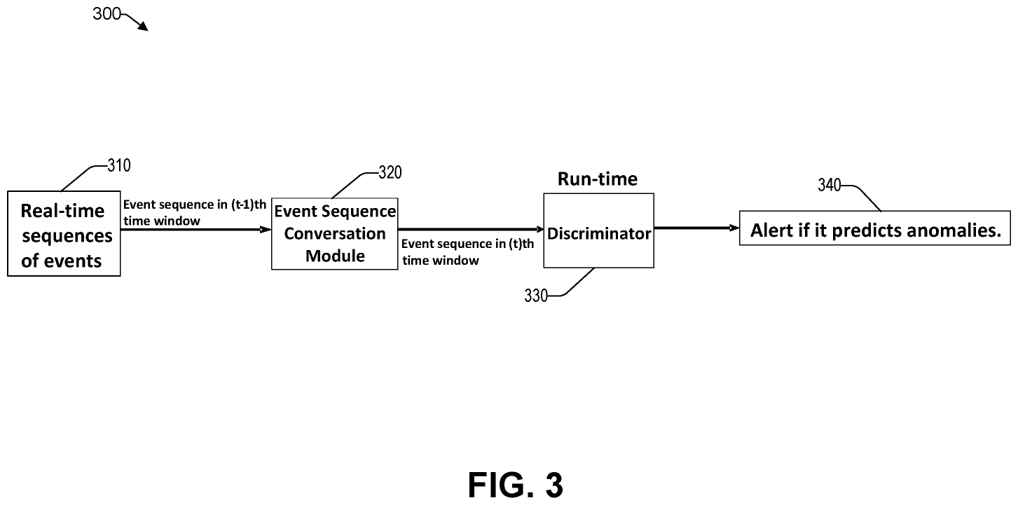

According to an embodiment, a computer program product for anomaly detection using event sequence prediction is provided. The computer program product includes a computer readable storage medium embodying program instructions executable by a processor to cause the processor to perform a plurality of steps. These steps may correlate to any process steps/functions relative to any of FIGS. 3-12.

Reference is now made to FIG. 3, which is a flowchart showing an example process for anomaly detection using event sequence prediction performed in the computing system 205 shown in FIG. 2, consistent with an illustrative embodiment. For discussion purposes, the flowchart 300 is described with reference to the architecture of environment 100 and computing system 205 of FIGS. 1 and 2. It is noted that the flow embodied in flowchart 300 embodies an exemplary method for anomaly detection using event sequence prediction.

As shown, a step 310 includes providing a real-time sequence of events, including an event sequence in a (t−1)th time window, to event sequence conversation module 250. At block, 320, event sequence conversation module 350 generates an event sequence in (t)th (next) time window. At block 330, a discriminator compares the two event sequence datasets (trained with the event sequence data) in order to determine anomalies within the event sequence datasets. At block 340, an alert is generated if the discriminator predicts any anomalies.

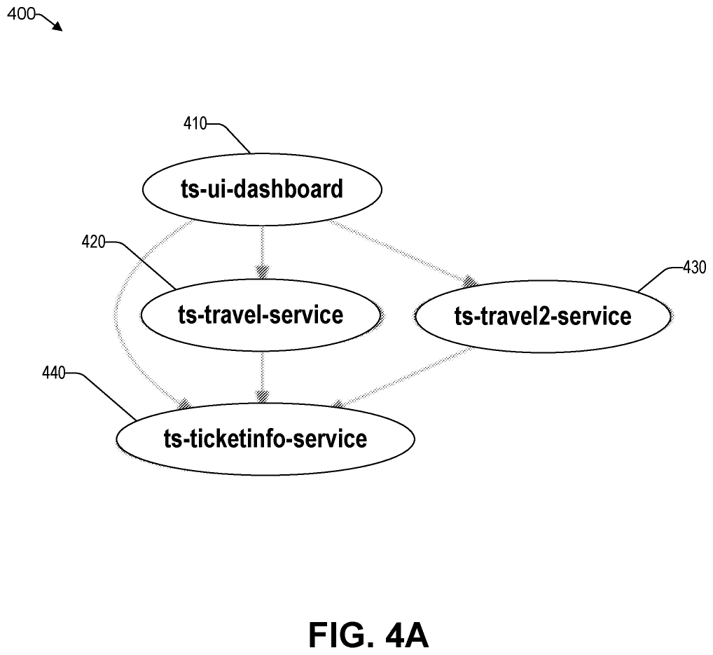

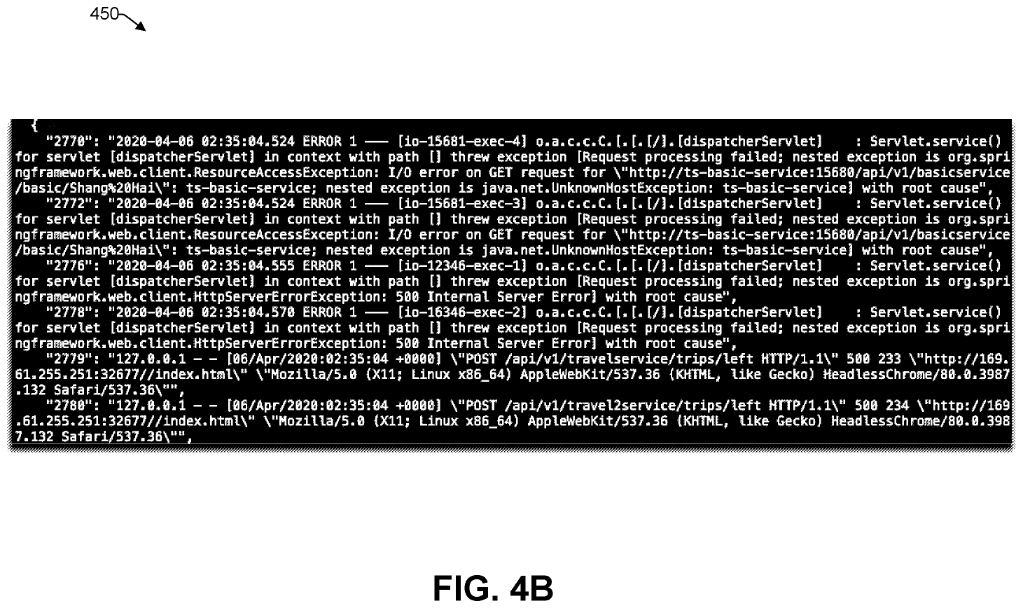

Reference is now made to FIG. 4A, which is a flowchart showing a microservices architecture of an example distributed system 400, consistent with an illustrative embodiment. As shown, distributed system 400 is a benchmarked train ticket system. At block 410, ts-ui-dashboard sends travel information to ts-travel-service at block 420, to ts-travel2-service at block 430, and to ts-ticketinfo-service at block 440. At block 420, ts-travel-service sends source and destination station details to ts-ticketinfo-service at block 440. At block 430, ts-travel2-service also sends source and destination station details to ts-ticketinfo-service at block 440.

Reference is now made to FIG. 4B, which presents example computer readable code 450 presenting partial logs of error propagation among microservices of the example distributed system of FIG. 4A, consistent with an illustrative embodiment. As shown, an event sequence conversation between ts-ticketinfo-service, ts-travel-service, ts-travel2-service, and ts-ui-dashboard is embodied within code 450 that presents a propagated error with a root cause. Within this example, event sequence conversation can be extracted from the following logs: “1. ts-us-dashboard sends the travel information to ts-travel-service”, “2. ts-travel-service sends the source destination station details to ts-ticketinfo-service”, and “3. ts-ticketinfo-service sends the ticket information to ts-travel-service”.

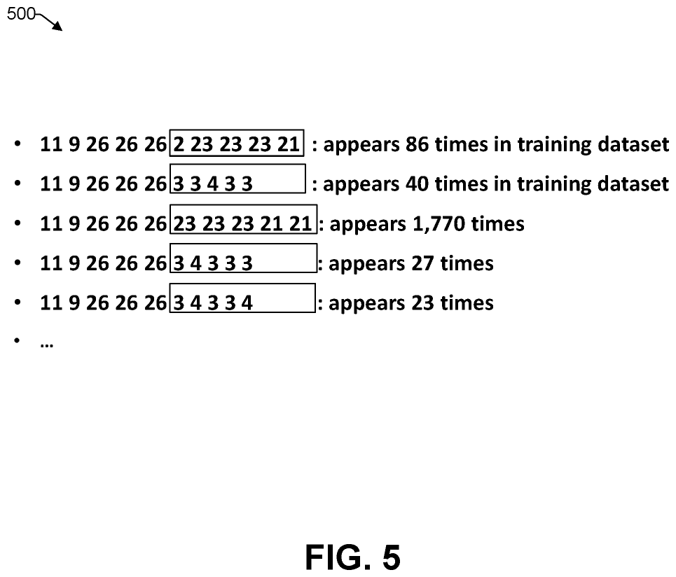

Reference is now made to FIG. 5, which is an example log data set 500 embodying an event sequence conversation, consistent with an illustrative embodiment. As shown, log data set 500 is a Hadoop Distributed File System (HDFS) log data set. In an embodiment, log data set 500 is generated through Hadoop-based map-reduce jobs on over 200 nodes (in this case, Amazon EC2 nodes) and is labeled by Hadoop domain experts (SMEs). The number of sessions performed to output log data set 500 is 4,855 sessions, where 41,856 identified sequence pairs form a training dataset. Within the training dataset, an event sequence “11 9 26 26 26” appears 3,129 times, where the number “1 1” represents a log template id. When the training dataset was further run/generated, additional event sequences were identified. For example, “2 23 23 23 21” appears 86 times in the training dataset, “3 3 4 3 3” appears 40 times in the training dataset, “23 23 23 21 21” appears 1,770 times in the training dataset, “3 4 3 3 3” appears 27 times in the training dataset, and “3 4 3 3 4” appears 23 times in the training dataset.

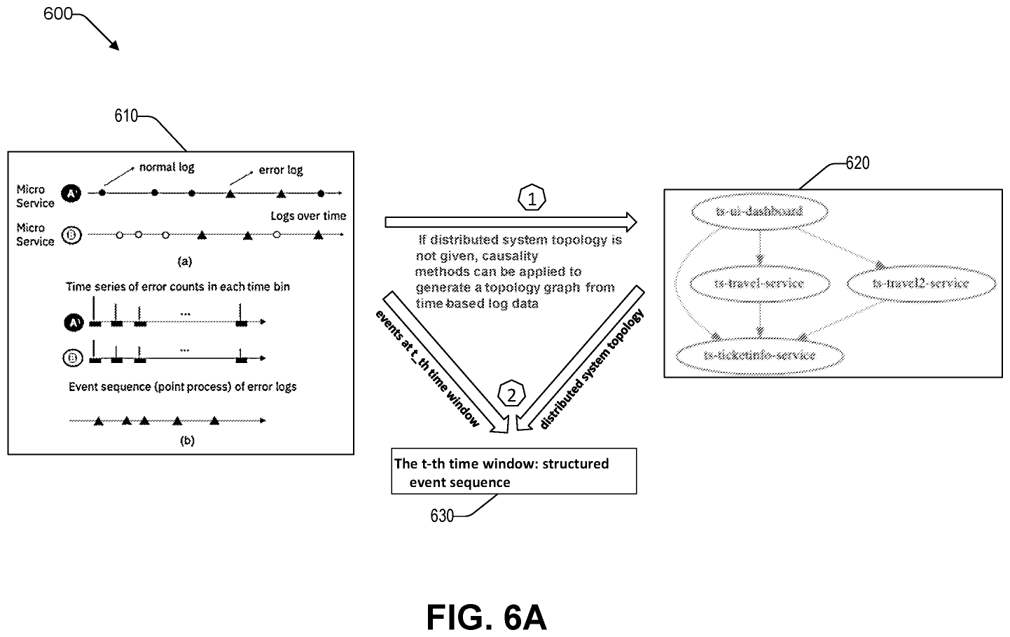

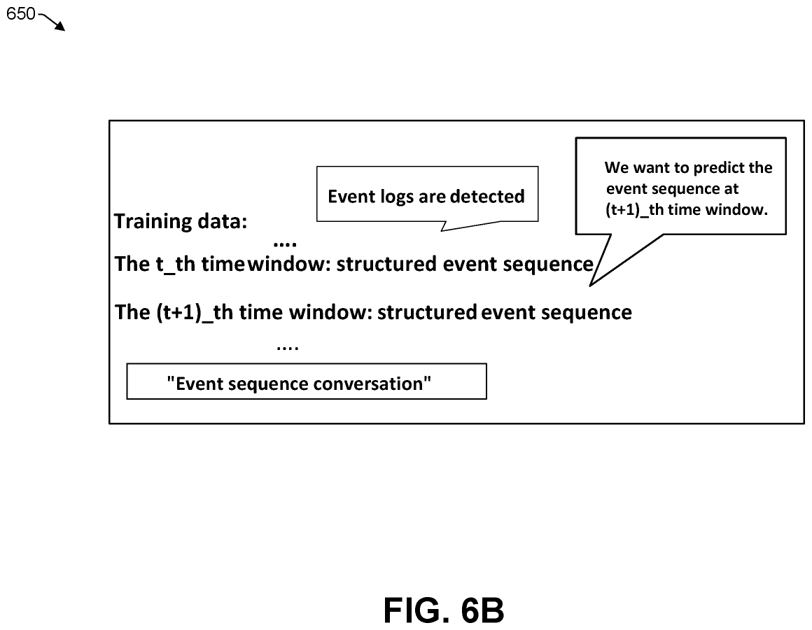

FIG. 6A is a flowchart showing an example of a conversion of time-based log data to a structured event sequence, consistent with an illustrative embodiment. As shown, the process shown is an example of the preprocessing 220 of FIG. 2. At block 610, time-based log data relating to multiple microservices is restructured by removing repeated data and noise/special characters; this process can be carried out, for example, by preprocessing module 230 found in FIG. 2. The output from this process includes an event sequence of error logs. If distributed system topology information is included within the error log event sequence, the event sequence is structured and is stored as a structured event sequence at block 630.

If distributed system topology information is not given (in relation to the error log event sequence), causality methods can be applied to the time-based log data to generate a topology graph. As shown, distributed system 400 of FIG. 4A is presented as an example topology graph derived from the time-based log data. Once the topology is applied to the error log event sequence, the structured event sequence is stored as a structured event sequence at block 630. Once a structured event sequence is derived, the sequence is ready to be utilized as a training dataset by an event sequence generation engine, such as, for example, event sequence generation engine 260 of FIG. 2.

In an embodiment, the structured event sequence can be stored in event sequence conversation module 250 (of FIG. 2) at block 630.

Reference is now made to FIG. 6B, which is a graphical representation of an event sequence conversation, consistent with an illustrative embodiment. As shown, training data consists of structured event sequences in a t_th time window and structured event sequences in a (t+1)_th time window. In order to create the structured event sequences in a t_th time window, data preprocessing module 230 “communicates” to event sequence conversation module 250 that event logs are detected (historical log data 210). Once historical log data 210 is processed by event sequence conversation module 250 and run through event sequence generation engine 260, data preprocessing module 230 “communicates” to event sequence conversation module 250 that a prediction for an event sequence at a (t+1)_th time window is requested based on the processed historical log data 210.

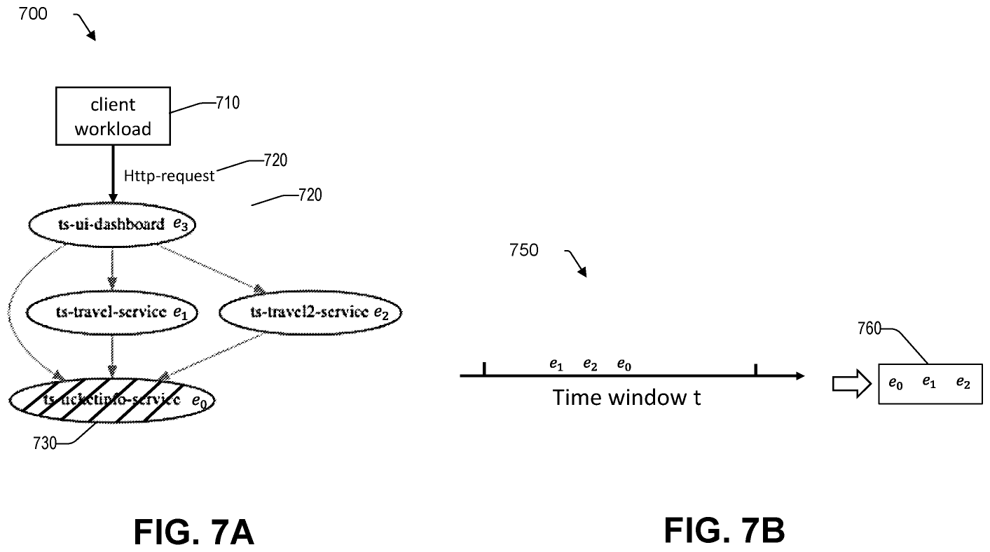

Reference is now made to FIG. 7A, which is a flowchart showing an example microservices architecture of a publicly benchmarked train ticket system including a root cause 730 of abnormal events, consistent with an illustrative embodiment. It is noted that FIG. 7A is described with reference to the preprocessing 720 of FIG. 2. As shown, an HTTP request 720 including a client workload 710 is sent to a server of the publicly benchmarked train ticket system. In response to the workload 710 being run through the train ticket system, preprocessed abnormal events are derived in a time window (FIG. 7B) using the distributed system architecture/a causality graph. The abnormal events are mapped to the topology of the train ticket system and are sorted if the time difference between two events pass a specific threshold (in this case, for example, if the time difference between two events is less than or equal to two seconds). For the event log sequence, e₁ happened at t₁=100 seconds, e₂ happened at t₂=101 seconds, and e₀ happened at t₀=102 seconds; these events are plotted on the time window of FIG. 7B. A structured event sequence is then created at block 760 (for example, via event sequence conversation module 750).

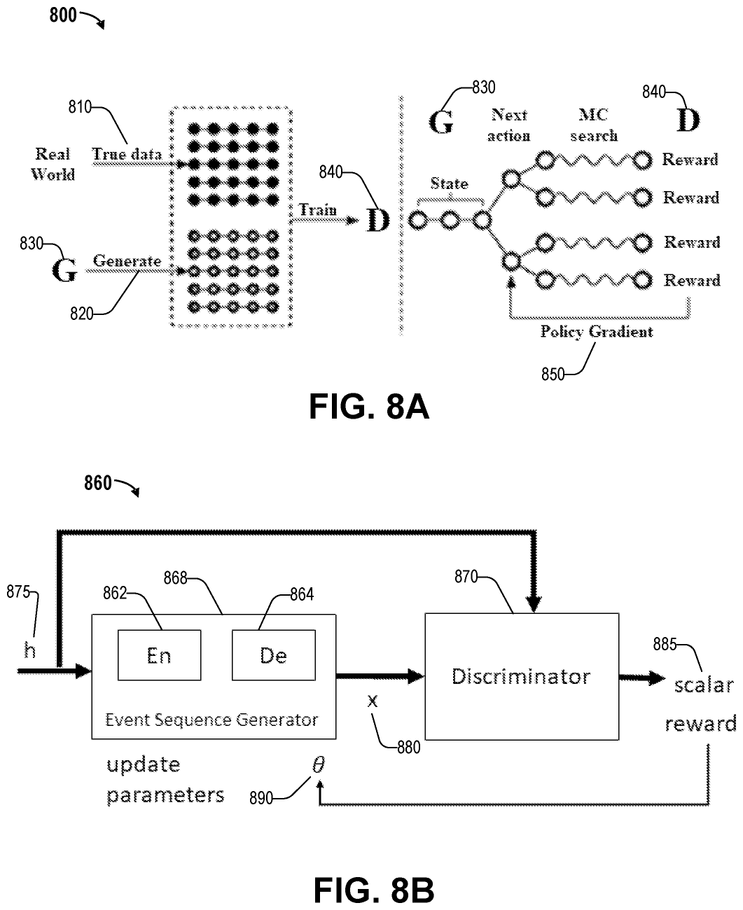

Reference is now made to FIG. 8A, which is a flowchart showing an example architecture of a sequence generative adversarial net (SeqGAN) 800 including a policy gradient 850, consistent with an illustrative embodiment. As shown, discriminator 840 (presented as D) is trained over true data 810 from the real world and generated data 820 from generator 830 (presented as G). Generator 830 is trained by policy gradient 850, where the final reward signal is provided by discriminator 840 and is passed back to the intermediate action value via a (e.g., Monte Carlo) search.

Reference is now made to FIG. 8B, which is a flowchart showing an example architecture of an event sequence generation engine 860, consistent with an illustrative embodiment. As shown, real data “h” 875 is supplied to event sequence generator 868 and discriminator 870. Event sequence generator 868 includes encoder 862 and decoder 864 that are utilized to encode and decode real data 875 to create generated data “x” 880 configured to mimic real data 875. Discriminator 870 then analyzes real data 875 and generated data 880 and assigns a probability/confidence score to each data sample that embodies the discriminator's belief in each sample's authenticity. Each probability/confidence score, also referred to as scalar/reward 885, are sent to event sequence generator 868, where event sequence generator 868 updates its parameters “0” 890 to create more accurate/convincing data samples and maximize scalar/reward 885.

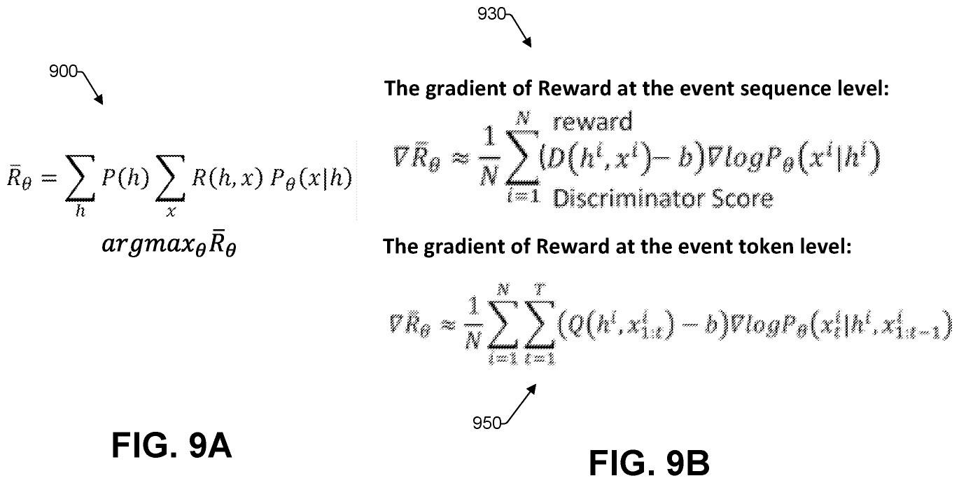

Reference is now made to FIG. 9A, which is an objective equation 900 of a reinforcement learning reward mechanism, consistent with an illustrative embodiment. As shown, equation 900 represents an objective function of discriminator 870 of FIG. 8B, where R(h,x) represents a “reward”. For example, consider a scenario, where an event sequence example in a time window includes variables hi=e₀, e₂ and xi=e₃, e₁, and each event is considered a token. Utilizing equation 900, a policy gradient defining a reward at an event sequence level can be derived, presented as equation 930 in FIG. 9B. The reward is defined as D(hⁱ, xⁱ) and represents a discriminator/probability score for a specific event sequence. This reward represents feedback given by a discriminate model predict state action value by a Monte Carlo search. Additionally utilizing equation 900, a policy gradient defining a reward at an event token level can be derived, presented as equation 950 in FIG. 9B. The reward is defined as Q(hⁱ, xⁱ_{1:t}) and represents a discriminator/probability score for a specific event token. This reward represents the number of correct ordered pair events of generated event sequences based on the topology. It is noted that, in relation to FIG. 9B, a generator (G) is trained by a policy gradient, where the reward is provided by a discriminator (D).

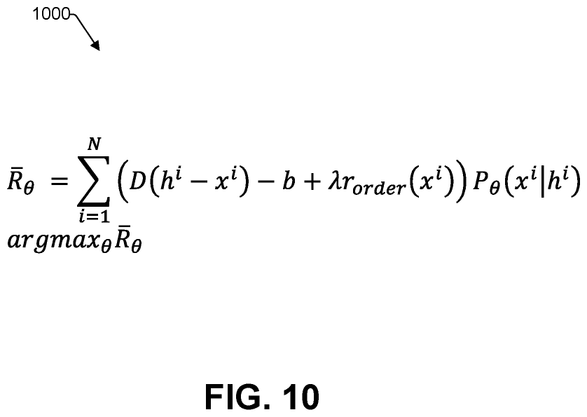

Reference is now made to FIG. 10, which is an equation 1000 presenting an event sequence reward function including a bias portion, consistent with an illustrative embodiment. Equation 1000 is similar to equation 930 of FIG. 9B, but also includes a bias that includes a constant λ that fine-tunes the sequence reward. The bias is represented as λr_{order}(xⁱ), where:

$${r}_{order} ( {x}^{i} ) = \frac{the number of ordered event pairs in {x}^{i}}{\begin{matrix}the total number of ordered \\ event pairs in the topology ( hops = 1 )\end{matrix}}$$

Additionally, r_{order}(xⁱ) is an event sequence reward function and represents the number of correct ordered pair events of generated event sequences based on a topology.

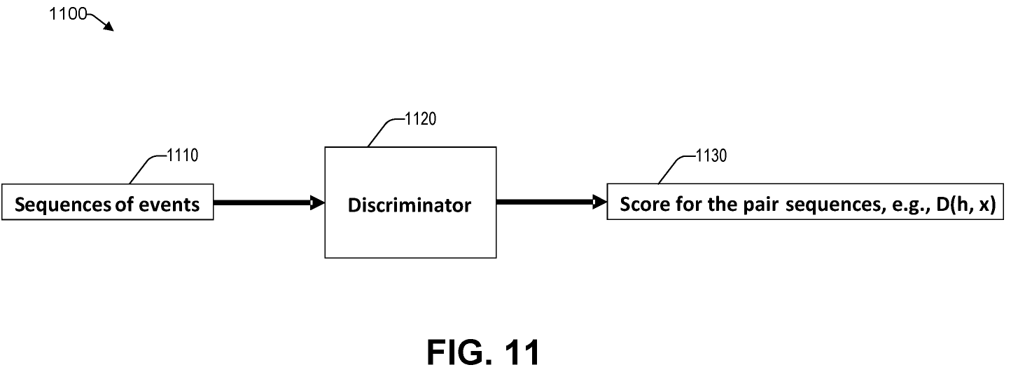

Reference is now made to FIG. 11, which is a flowchart showing an example process for anomaly detection using event sequence prediction performed in the computing system 205 shown in FIG. 2, consistent with an illustrative embodiment.

For discussion purposes, the flowchart 1100 is described with reference to the architecture of environment 100, computing system 205, and event sequence generation engine 860 of FIGS. 1, 2, and 8B. It is noted that the flow embodied in flowchart 1100 embodies an exemplary method for anomaly detection using event sequence prediction. It is noted that generator 868 and discriminator 870 are trained using GAN architecture to produce a “normal” event sequence, where a “normal” event sequence means that the sequence is a frequent sequence in the dataset.

As shown, a step 1110 includes providing a “real-world” event sequence to discriminator 870. At block 1120, discriminator 870 makes inferences about the “real-world” event sequence. At block 1130, discriminator 870 provides a feedback (to generator 868) in the form of a probability of the sequence event, represented as D(hⁱ, xⁱ). Discriminator 870, based on its training, has a probability threshold for an “acceptable” probability score. A low probability (below the threshold) indicates that the sequence can be abnormal and can be flagged/labeled as such. In the case of an anomaly, in an embodiment, a sequence with the lowest score among neighbors is reported as an anomaly.

As a specific example, real data 875 is run as h=(a, b, c), generated data 880 is run as x=(d, f), and a probability D(h, x)=1 is output. A sequence observed is z=(d). The observed sequence can be identified as an anomaly (or not) by calculating D(h, z) using discriminator 870 and comparing it to the probability threshold.

With the foregoing overview of the example architecture/environment/computing system 100,200, it may be helpful to consider a high-level discussion of an example process. To that end FIG. 12 presents a flowchart 1200 for a method for anomaly detection using event sequence prediction, consistent with an illustrative embodiment.

Flowchart 1200 is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the method for anomaly detection using event sequence prediction is described with reference to the architecture of environment 100 and system 200 of FIGS. 1 and 2.

At block 1210, an event sequence conversation module 250 applies a system topology to historical log data 210 to generate a first plurality of structured event sequences labeled as training data.

At block 1220, an event sequence generation engine 260 builds a machine learning model using the training data, where the event sequence generation engine 260 calculates a probability threshold for each of the first plurality of structured event sequences using the machine learning model.

At block 1230, the event sequence conversation module 250 applies a system topology to runtime log data 270 to generate a second plurality of structured event sequences 280.

At block 1240, the event sequence generation engine 260 runs the second plurality of structured event sequences 280 through the machine learning model.

At block 1250, the event sequence generation engine 260 calculates a probability for each of the second plurality of structured event sequences 280 using the machine learning model.

At block 1260, the event sequence generation engine 260 identifies the probabilities for each of the second plurality of structured event sequences 280 that are lower than the probability threshold of classified event sequences of the first plurality of structured event sequences as anomalies.

In an embodiment, historical log data 210 and runtime log data 270 are extracted from a distributed system.

In one embodiment, event sequence generation engine 260 utilizes an adversarial reinforcement learning model. In a further embodiment, the adversarial reinforcement learning model comprises a SeqGAN architecture.

In one embodiment, the method for anomaly detection using event sequence prediction of flowchart 1200 further includes processing, by preprocessing module 230, historical log data 210 and runtime log data 270, where each log entry of historical log data 210 and runtime log data 270 is processed as a log template.

In one embodiment, the method for anomaly detection using event sequence prediction of flowchart 1200 further includes providing, via a graphical user interface, the second plurality of structured event sequences 280 to SMEs 285, wherein the SMEs 285 perform at least one of: reviewing or amending the second plurality of structured event sequences 280.

In one embodiment, the probability threshold is formed using an event sequence reward including a number of correctly ordered generated event sequences based on a system topology.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for anomaly detection using an event sequence conversation module and an event sequence generation engine, the method comprising:
applying, via the event sequence conversation module, a system topology to a historical log data to generate a first plurality of structured event sequences labeled as training data;
building, via the event sequence generation engine, a machine learning model using the training data, wherein the event sequence generation engine calculates a probability threshold for each of the first plurality of structured event sequences using the machine learning model;
applying, via the event sequence conversation module, a system topology to runtime log data to generate a second plurality of structured event sequences;
running, via the event sequence generation engine, the second plurality of structured event sequences through the machine learning model;
calculating, by the event sequence generation engine, a probability for each of the second plurality of structured event sequences using the machine learning model; and
identifying, by the event sequence generation engine, the probabilities for each of the second plurality of structured event sequences that are lower than the probability threshold of classified event sequences of the first plurality of structured event sequences as anomalies.

2. The method of claim 1, wherein the historical log data and the runtime log data are extracted from a distributed system.

3. The method of claim 1, wherein the event sequence generation engine utilizes an adversarial reinforcement learning model.

4. The method of claim 3, wherein the adversarial reinforcement learning model comprises a SeqGAN architecture.

5. The method of claim 1, further comprising processing, by a preprocessing module, the historical log data and the runtime log data, wherein each log entry of the historical log data and the runtime log data is processed as a log template.

6. The method of claim 1, further comprising providing, via a graphical user interface, the second plurality of structured event sequences to SMEs, wherein the SMEs perform at least one of: reviewing or amending the second plurality of structured event sequences.

7. The method of claim 1, wherein the probability threshold is formed using an event sequence reward comprising a number of correctly ordered generated event sequences based on a system topology.

8. A computer program product for anomaly detection, the computer program product comprising a computer readable storage medium having program instructions embodied therewith, the program instructions executable by a processor to cause the processor to perform:
applying, via an event sequence conversation module, a system topology to historical log data to generate a first plurality of structured event sequences labeled as training data;
building, via an event sequence generation engine, a machine learning model using the training data, wherein the event sequence generation engine calculates a probability threshold for each of the first plurality of structured event sequences using the machine learning model;
applying, via the event sequence conversation module, a system topology to runtime log data to generate a second plurality of structured event sequences;
running, via the event sequence generation engine, the second plurality of structured event sequences through the machine learning model; and
calculating, by the event sequence generation engine, a probability for each of the second plurality of structured event sequences using the machine learning model; and
identifying, by the event sequence generation engine, the probabilities for each of the second plurality of structured event sequences that are lower than the probability threshold of classified event sequences of the first plurality of structured event sequences as anomalies.

9. The computer program product of claim 8, wherein the historical log data and the runtime log data are extracted from a distributed system.

10. The computer program product of claim 8, wherein the event sequence generation engine utilizes an adversarial reinforcement learning model.

11. The computer program product of claim 10, wherein the adversarial reinforcement learning model comprises a SeqGAN architecture.

12. The computer program product of claim 8, further comprising processing, by a preprocessing module, the historical log data and the runtime log data, wherein each log entry of the historical log data and the runtime log data is processed as a log template.

13. The computer program product of claim 8, further comprising providing, via a graphical user interface, the second plurality of structured event sequences to SMEs, wherein the SMEs perform at least one of: reviewing or amending the second plurality of structured event sequences.

14. A computing system comprising:
a processor;
a network module coupled to the processor to enable communication over a network;
a computer-readable storage device coupled to the processor;
a graphical user interface coupled to the processor;
an event sequence conversation module coupled to the network module;
an event sequence generation engine coupled to the network module; and
program instructions stored on the computer-readable storage device for execution by the processor via a memory, wherein execution of the instructions by the processor configures the computing system to perform an anomaly detection method comprising:
applying, via the event sequence conversation module, a system topology to historical log data to generate a first plurality of structured event sequences labeled as training data;
building, via the event sequence generation engine, a machine learning model using the training data, wherein the event sequence generation engine calculates a probability threshold for each of the first plurality of structured event sequences using the machine learning model;
applying, via the event sequence conversation module, a system topology to runtime log data to generate a second plurality of structured event sequences;
running, via the event sequence generation engine, the second plurality of structured event sequences through the machine learning model; and
calculating, by the event sequence generation engine, a probability for each of the second plurality of structured event sequences using the machine learning model; and
identifying, by the event sequence generation engine, the probabilities for each of the second plurality of structured event sequences that are lower than the probability threshold of classified event sequences of the first plurality of structured event sequences as anomalies.

15. The computing system of claim 14, wherein the historical log data and the runtime log data are extracted from a distributed system.

16. The computing system of claim 14, wherein the event sequence generation engine utilizes an adversarial reinforcement learning model.

17. The computing system of claim 16, wherein the adversarial reinforcement learning model comprises a SeqGAN architecture.

18. The computing system of claim 16, further comprising processing, by a preprocessing module, the historical log data and the runtime log data, wherein each log entry of the historical log data and the runtime log data is processed as a log template.

19. The computing system of claim 16, further comprising providing, via the graphical user interface, the second plurality of structured event sequences to SMEs, wherein the SMEs perform at least one of: reviewing or amending the second plurality of structured event sequences.

20. The computing system of claim 14, wherein the probability threshold is formed using an event sequence reward comprising a number of correctly ordered generated event sequences based on a system topology.
